(19) United States
(12) Patent Application Publication
(10) Pub. No.: US 2022/0299322 A1
(43) Pub. Date: Sep. 22, 2022

(54) VEHICLE POSITION ESTIMATION APPARATUS

(71) Applicant: Honda Motor Co., Ltd., Tokyo (JP)

(72) Inventor: Hayato Ikeda, Wako-shi (JP)

(21) Appl. No.: 17/676,750

(22) Filed: Feb. 21, 2022

(30) Foreign Application Priority Data
Mar. 17, 2021 (JP) 2021-043047

(51) Int. Cl. G01C 21/30; B60W 60/00

(52) U.S. Cl. CPC G01C 21/30; B60W 60/0051; B60W 2420/42

(57) ABSTRACT

A vehicle position estimation apparatus including a detection device that detects an external situation around a subject vehicle, and an electronic control unit including a microprocessor and a memory connected to the microprocessor. The memory is configured to store a map information including an information on a landmark, and the microprocessor is configured to perform recognizing the landmark around the subject vehicle, based on an information on the external situation detected by the detection device, determining whether the landmark recognized is a variable landmark, a mode of the variable landmark changing in accordance with a time zone, controlling the memory so as to store the information on the landmark recognized, in accordance with a determination result, and estimating a position of the subject vehicle, based on the map information stored in the memory.

### CROSS-REFERENCE TO RELATED APPLICATION

This application is based upon and claims the benefit of priority from Japanese Patent Application No. 2021-043047 filed on Mar. 17, 2021, the content of which is incorporated herein by reference.

### BACKGROUND OF THE INVENTION

### Field of the Invention

This invention relates to a vehicle position estimation apparatus estimating a position of a subject vehicle.

### Description of the Related Art

Conventionally, as this type of apparatus, there is a known apparatus that compares a peripheral image captured by an in-vehicle camera with a position image, which is a scenery image at each position preliminarily registered in a database, selects a position image highly similar to the peripheral image, and estimates a position corresponding to the selected image as a vehicle position. Such an apparatus is described, for example, in Japanese Unexamined Patent Publication No. 2019-196981 (JP2019-196981A).

When a vehicle travels in different time zones, however, captured scenery images may be different from each other even if the vehicle travels through the same point. The configuration of the apparatus described in JP2019-196981A thus has difficulty in accurately estimating a vehicle position.

### SUMMARY OF THE INVENTION

An aspect of the present invention is a vehicle position estimation apparatus including a detection device that detects an external situation around a subject vehicle, and an electronic control unit including a microprocessor and a memory connected to the microprocessor. The memory is configured to store a map information including an information on a landmark. The microprocessor is configured to perform recognizing the landmark around the subject vehicle, based on an information on the external situation detected by the detection device, determining whether the landmark recognized is a variable landmark, a mode of the variable landmark changing in accordance with a time zone, controlling the memory so as to store the information on the landmark recognized, in accordance with a determination result, and estimating a position of the subject vehicle, based on the map information stored in the memory.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system in a self-driving vehicle to which a vehicle position estimation apparatus according to an embodiment of the present invention is applied;

FIG. 2A is a view illustrating an example of a camera image acquired by an on-board camera of the subject vehicle having the vehicle position estimation generation apparatus according to the embodiment of the present invention;

FIG. 2B is a view illustrating another example of the camera image acquired by the on-board camera of the subject vehicle having the vehicle position estimation generation apparatus according to the embodiment of the present invention;

FIG. 3 is a block diagram illustrating a configuration of a substantial part of the vehicle position estimation apparatus according to the embodiment of the invention; and

FIG. 4 is a flowchart illustrating an example of processing executed by a controller in FIG. 3.

### DETAILED DESCRIPTION OF THE INVENTION

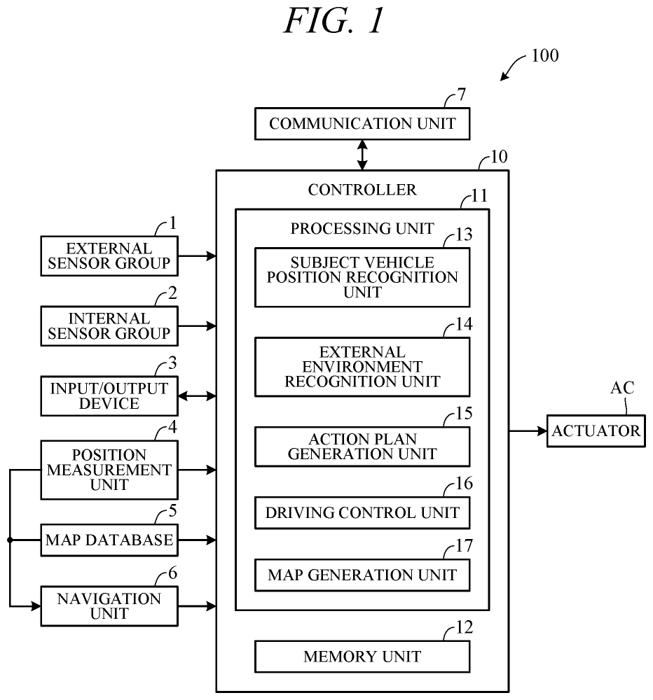

Hereinafter, an embodiment of the present invention is explained with reference to FIGS. 1 to 4. A vehicle position estimation apparatus according to an embodiment of the invention is applied to a vehicle having a self-driving capability, i.e., a self-driving vehicle. The vehicle position estimation apparatus can be also used by a manual driving vehicle. The vehicle to which the vehicle position estimation apparatus according to the embodiment is applied may be sometimes called “subject vehicle” to differentiate it from other vehicles. The subject vehicle is an engine vehicle having an internal combustion engine (engine) as a travel drive source, electric vehicle having a travel motor as the travel drive source, or hybrid vehicle having both of the engine and the travel motor as the travel drive source. The subject vehicle can travel not only in a self-drive mode in which a driving operation by a driver is unnecessary, but also in a manual drive mode in which the driving operation by the driver is necessary.

First, the general configuration of the subject vehicle for self-driving will be explained. FIG. 1 is a block diagram schematically illustrating an overall configuration of a vehicle control system 100 of the self-driving vehicle to which the vehicle position estimation apparatus according to an embodiment of the present invention is applied. As shown in FIG. 1, the vehicle control system 100 mainly includes a controller 10, and an external sensor group 1, an internal sensor group 2, an input/output device 3, a position measurement unit 4, a map database 5, a navigation unit 6, a communication unit 7 and actuators AC which are communicably connected with the controller 10.

The term external sensor group 1 herein is a collective designation encompassing multiple sensors (external sensors) for detecting external circumstances constituting subject vehicle ambience data. For example, the external sensor group 1 includes, inter alia, a LIDAR (Light Detection and Ranging) for measuring distance from the subject vehicle to ambient obstacles by measuring scattered light produced by laser light radiated from the subject vehicle in every direction, a RADAR (Radio Detection and Ranging) for detecting other vehicles and obstacles around the subject vehicle by radiating electromagnetic waves and detecting reflected waves, and a CCD, CMOS or other image sensor-equipped on-board cameras for imaging subject vehicle ambience (forward, reward and sideways).

The term internal sensor group 2 herein is a collective designation encompassing multiple sensors (internal sensors) for detecting driving state of the subject vehicle. For example, the internal sensor group 2 includes, inter alia, a vehicle speed sensor for detecting vehicle speed of the subject vehicle, acceleration sensors for detecting forward-rearward direction acceleration and lateral acceleration of the subject vehicle, respectively, rotational speed sensor for detecting rotational speed of the travel drive source, a yaw rate sensor for detecting rotation angle speed around a vertical axis passing center of gravity of the subject vehicle and the like. The internal sensor group 2 also includes sensors for detecting driver driving operations in manual drive mode, including, for example, accelerator pedal operations, brake pedal operations, steering wheel operations and the like.

The term input/output device 3 is used herein as a collective designation encompassing apparatuses receiving instructions input by the driver and outputting information to the driver. The input/output device 3 includes, inter alia, switches which the driver uses to input various instructions, a microphone which the driver uses to input voice instructions, a display for presenting information to the driver via displayed images, and a speaker for presenting information to the driver by voice.

The position measurement unit (GNSS unit) 4 includes a position measurement sensor for receiving signal from positioning satellites to measure the location of the subject vehicle. The position measurement sensor may be included in the internal sensor group 2. The positioning satellites are satellites such as GPS satellites and Quasi-Zenith satellite. The position measurement unit 4 measures absolute position (latitude, longitude and the like) of the subject vehicle based on signal received by the position measurement sensor.

The map database 5 is a unit storing general map data used by the navigation unit 6 and is, for example, implemented using a magnetic disk or semiconductor element. The map data include road position data and road shape (curvature etc.) data, along with intersection and road branch position data. The map data stored in the map database 5 are different from high-accuracy map data stored in a memory unit 12 of the controller 10.

The navigation unit 6 retrieves target road routes to destinations input by the driver and performs guidance along selected target routes. Destination input and target route guidance is performed through the input/output device 3. Target routes are computed based on current position of the subject vehicle measured by the position measurement unit 4 and map data stored in the map database 35. The current position of the subject vehicle can be measured, using the values detected by the external sensor group 1, and on the basis of this current position and high-accuracy map data stored in the memory unit 12, target route may be calculated.

The communication unit 7 communicates through networks including the Internet and other wireless communication networks to access servers (not shown in the drawings) to acquire map data, travel history information of other vehicle, traffic data and the like, periodically or at arbitrary times. In addition to acquiring travel history information of the other vehicle, travel history information of the subject vehicle may be transmitted to the server via the communication unit 7. The networks include not only public wireless communications network, but also closed communications networks, such as wireless LAN, Wi-Fi and Bluetooth, which are established for a predetermined administrative area. Acquired map data are output to the map database 5 and/or memory unit 12 via the controller 10 to update their stored map data.

The actuators AC are actuators for traveling of the subject vehicle. If the travel drive source is the engine, the actuators AC include a throttle actuator for adjusting opening angle of the throttle valve of the engine (throttle opening angle). If the travel drive source is the travel motor, the actuators AC include the travel motor. The actuators AC also include a brake actuator for operating a braking device and turning actuator for turning the front wheels FW.

The controller 10 is constituted by an electronic control unit (ECU). More specifically, the controller 10 incorporates a computer including a CPU or other processing unit (a microprocessor) 51 for executing a processing in relation to travel control, the memory unit (a memory) 12 of RAM, ROM and the like, and an input/output interface or other peripheral circuits not shown in the drawings. In FIG. 1, the controller 10 is integrally configured by consolidating multiple function-differentiated ECUs such as an engine control ECU, a transmission control ECU and so on. Optionally, these ECUs can be individually provided.

The memory unit 12 stores high-accuracy detailed road map data (road map information). The road map information includes information on road position, information on road shape (curvature, etc.), information on gradient of the road, information on position of intersections and branches, information on the number of lanes, information on width of lane and the position of each lane (center position of lane and boundary line of lane), information on position of landmarks (traffic lights, signs, buildings, etc.) as a mark on the map, and information on the road surface profile such as unevennesses of the road surface, etc. The information on the landmark (landmark information) includes information such as the shape (outline), characteristics, and position of the landmark. The information on the characteristics of a landmark relates to whether or not the appearance of the landmark changes depending on a time zone, weather, or climate for example.

The map information stored in the memory unit 12 includes map information (referred to as external map information) acquired from the outside of the subject vehicle through the communication unit 7, and map information (referred to as internal map information) created by the subject vehicle itself using the detection values of the external sensor group 1 or the detection values of the external sensor group 1 and the internal sensor group 2. The external map information is, for example, information of a map (called a cloud map) acquired through a cloud server, and the internal map information is information of a map (called an environment map) consisting of point cloud data generated by mapping using a technique such as SLAM (Simultaneous Localization and Mapping). The external map information is shared by the subject vehicle and other vehicles, whereas the internal map information is unique map information of the subject vehicle (e.g., map information that the subject vehicle has alone).

The memory unit 12 also stores information on various control programs and thresholds used in the programs. The memory unit 12 further stores travel history information on the subject vehicle, which has been acquired by the internal sensor group 2, in association with highly accurate map information (e.g., environment map information). The travel history information indicates that in what mode the subject vehicle traveling by manual driving traveled on a road in the past. Information such as a travel route and travel date and time and information such as a vehicle speed and the level of acceleration/deceleration are stored as the travel history information in association with road position information.

As functional configurations in relation to mainly self-driving, the processing unit 11 includes a subject vehicle position recognition unit 13, an external environment recognition unit 14, an action plan generation unit 15, a driving control unit 16, and a map generation unit 17.

The subject vehicle position recognition unit 13 recognizes the position of the subject vehicle (subject vehicle position) on the map based on position information of the subject vehicle calculated by the position measurement unit 4 and map information stored in the map database 5. Optionally, the subject vehicle position can be recognized using map information stored in the memory unit 12 and ambience data of the subject vehicle detected by the external sensor group 1, whereby the subject vehicle position can be recognized with high accuracy. For example, the subject vehicle position recognition unit 13 identifies a landmark included in the camera image, by comparing image information acquired by the camera during traveling with landmark image information preliminarily stored in the memory unit 12. Based on the identified landmark, the subject vehicle position can be recognized. Optionally, when the subject vehicle position can be measured by sensors installed externally on the road or by the roadside, the subject vehicle position can be recognized by communicating with such sensors through the communication unit 7.

The external environment recognition unit 14 recognizes external circumstances around the subject vehicle based on signals from cameras, LIDERs, RADARs and the like of the external sensor group 1. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic lights, road division lines (white lines, etc.) and stop lines, buildings, guardrails, power poles, commercial signs, pedestrians, bicycles, and the like. Recognized states of other objects include, for example, traffic light color (red, green or yellow) and moving speed and direction of pedestrians and bicycles. A part of a stationary object among other objects, constitutes a landmark serving as an index of position on the map, and the external environment recognition unit 14 also recognizes the position and type of the landmark.

The action plan generation unit 15 generates a driving path (target path) of the subject vehicle from present time point to a certain time ahead based on, for example, a target route computed by the navigation unit 6, map information stored in the memory unit 12, subject vehicle position recognized by the subject vehicle position recognition unit 13, and external circumstances recognized by the external environment recognition unit 14. When multiple paths are available on the target route as target path candidates, the action plan generation unit 15 selects from among them the path that optimally satisfies legal compliance, safe efficient driving and other criteria, and defines the selected path as the target path. The action plan generation unit 15 then generates an action plan matched to the generated target path. An action plan is also called “travel plan”. The action plan generation unit 15 generates various kinds of action plans corresponding to overtake traveling for overtaking the forward vehicle, lane-change traveling to move from one traffic lane to another, following traveling to follow the preceding vehicle, lane-keep traveling to maintain same lane, deceleration or acceleration traveling. When generating a target path, the action plan generation unit 15 first decides a drive mode and generates the target path in line with the drive mode.

In self-drive mode, the driving control unit 16 controls the actuators AC to drive the subject vehicle along target path generated by the action plan generation unit 15. More specifically, the driving control unit 16 calculates required driving force for achieving the target accelerations of sequential unit times calculated by the action plan generation unit 15, taking running resistance caused by road gradient and the like into account. And the driving control unit 16 feedback-controls the actuators AC to bring actual acceleration detected by the internal sensor group 2, for example, into coincidence with target acceleration. In other words, the driving control unit 16 controls the actuators AC so that the subject vehicle travels at target speed and target acceleration. On the other hand, in manual drive mode, the driving control unit 16 controls the actuators AC in accordance with driving instructions by the driver (steering operation and the like) acquired from the internal sensor group 2.

The map generation unit 17 generates the environment map constituted by three-dimensional point cloud data using detection values detected by the external sensor group 1 during traveling in the manual drive mode. Specifically, an edge indicating an outline of an object is extracted from a camera image acquired by the camera based on luminance and color information for each pixel, and a feature point is extracted using the edge information. The feature point is, for example, an intersection of the edges, and corresponds to a corner of a building, a corner of a road sign, or the like. The map generation unit 17 sequentially plots the extracted feature point on the environment map, thereby generating the environment map around the road on which the subject vehicle has traveled. The environment map may be generated by extracting the feature point of an object around the subject vehicle using data acquired by radar or LIDAR instead of the camera.

The subject vehicle position recognition unit 13 performs subject vehicle position estimation processing in parallel with map creation processing by the map generation unit 17. That is, the position of the subject vehicle is estimated based on a change in the position of the feature point over time. The map creation processing and the position estimation processing are simultaneously performed, for example, according to an algorithm of SLAM. The map generation unit 17 can generate the environment map not only when the vehicle travels in the manual drive mode but also when the vehicle travels in the self-drive mode. If the environment map has already been generated and stored in the memory unit 12, the map generation unit 17 may update the environment map with a newly obtained feature point.

The characteristic configuration of the vehicle position estimation apparatus according to the present embodiment will be described. The vehicle position estimation apparatus is configured to estimate the position of the subject vehicle, for example, when traveling in self-driving mode, by using the map information stored in the memory unit 12 in advance, especially the position information on the landmark as a reference, and by detecting the relative position of the subject vehicle relative to the landmarks by the external sensor group 1. Therefore, the vehicle position estimation apparatus needs to recognize the landmarks around the subject vehicle with high accuracy in order to estimate the position of the subject vehicle.

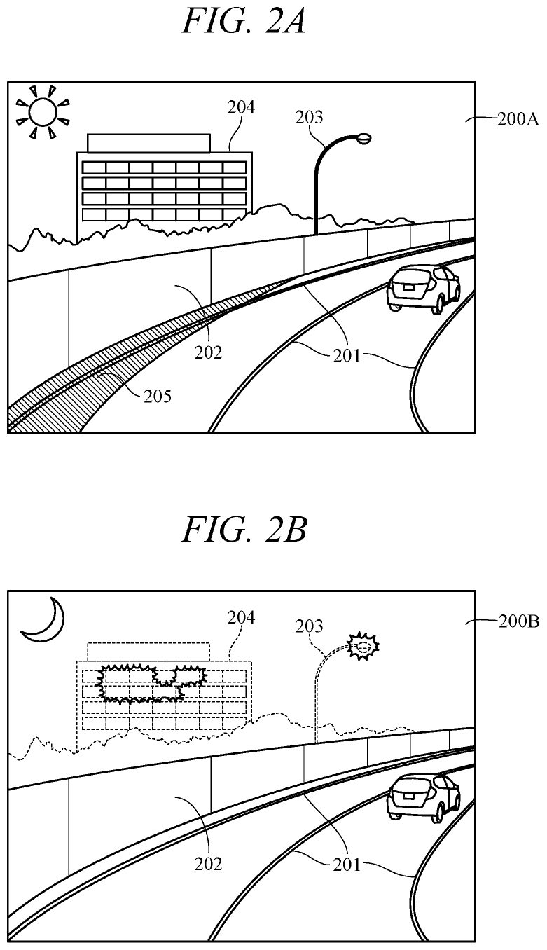

FIGS. 2A and 2B are images each captured by a camera (in-vehicle camera) of the subject vehicle including the vehicle position estimation apparatus. In particular, FIG. 2A is a camera image 200A captured when the subject vehicle traveled during the daytime (day) (referred to as daytime image). FIG. 2B is a camera image 200B captured when the subject vehicle traveled through the same point at night (referred to as nighttime image). Note that the daytime is a time zone from sunrise to sunset, for example. The nighttime is a time zone from sunset to sunrise, for example.

As illustrated in FIG. 2A, a division line image 201, a sidewall image 202, a streetlight image 203, a building image 204, and a shadow image 205 can be obtained from the daytime image 200A. The division line image 201 represents a division line. The sidewall image 202 represents a sidewall of a road. The streetlight image 203 represents a streetlight facing the road. The building image 204 represents the outline and windows of a building. The shadow image 205 represents a shadow (hatching) of the sidewall. A plurality of landmarks can thus be set by using these characteristic points on the images. Landmark information can be generated. In the landmark information, each of the division line, the sidewall, the streetlight, the building, and the shadow serves as a landmark.

In contrast, as illustrated in FIG. 2B, the division line image 201 and the sidewall image 202 can be obtained from the nighttime image 200B. The streetlight is turn off at daytime, but turned on at night. Further, the windows of the building are also illuminated by illumination. Therefore, it is difficult to clearly recognize the outlines of the streetlight and the building from the camera image. The streetlight image 203 and the building image 204 similar to those obtained from the daytime image 200A cannot thus be obtained from the nighttime image 200B. Since the sunlight generates no shadow at night, the shadow image 205 cannot also be obtained from the nighttime image 200B. Although landmark information on the division line and the sidewall can be generated from the nighttime image 200B, landmark information on the streetlight, the building, and the shadow cannot be generated.

As described above, the camera recognizes different landmarks between daytime and nighttime. The subject vehicle position recognition unit 13 (FIG. 1) has thus difficulty in estimating a subject vehicle position at night based on information on, for example, an uncertain landmark recognized only during the day (e.g., streetlight and shadow). Further, if such uncertain landmark information is left stored in the memory unit 12, the storage capacity will be compromised. In consideration of this point, in the present embodiment, the vehicle position estimation apparatus is configured as follows.

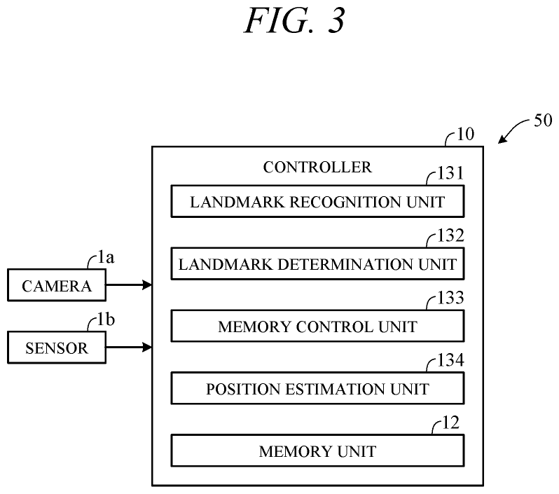

FIG. 3 is a block diagram illustrating the configuration of main parts of a vehicle position estimation apparatus 50 according to the present embodiment. The vehicle position estimation apparatus 50 includes a map information generation apparatus according to the present embodiment. In order to avoid complications, the configuration of the vehicle position estimation apparatus 50 will be described below so as to estimate the vehicle position during traveling in the self-drive mode. Before traveling in the self-drive mode, an environment map including landmark information is generated while the subject vehicle travels in the manual drive mode. Then, the subject vehicle travels in the self-drive mode, using this environment map

The vehicle position estimation apparatus 50 is included in the vehicle control system 100 in FIG. 1. As illustrated in FIG. 3, the vehicle position estimation apparatus 50 has a camera 1a, a sensor 1b and a controller 10.

The camera 1a is a monocular camera having an imaging element (image sensor) such as a CCD or a CMOS, and constitutes a part of the external sensor group 1 in FIG. 1. The camera 1a may be a stereo camera. The camera 1a is attached to, for example, a predetermined position in the front portion of the subject vehicle 101, continuously captures an image of a space in front of the subject vehicle 101, and acquires an image (camera image) of a target object. As illustrated in FIG. 2A, an object imaged by the camera 1a includes a shadow portion in addition to the streetlight, the building, the sidewall of a road, and the division line. That is, a material from which an edge indicating an outline can be extracted based on information on luminance and color of each pixel of a camera image, is the object. The sensor 1b is a detection part used to detect the relative position of the subject vehicle relative to the landmark. The sensor 1b is configure by the LIDAR, for example. The camera 1a may be used as the sensor 1b.

The controller 10 in FIG. 3 has a landmark recognition unit 131, a landmark determination unit 132, a memory control unit 133 and a position estimation unit 134, as a functional configuration of a processing unit 11 (FIG. 1). Since these landmark recognition unit 131, landmark determination unit 132, memory control unit 133 and position estimation unit 134 have a function for recognizing the subject vehicle position, these are included in the subject vehicle position recognition unit 13.

The memory unit 12 preliminarily stores information on a landmark around the subject vehicle. The landmark information includes information on the position and type of the landmark. The landmark information is obtained when the subject vehicle preliminarily travels while generating an environment map in the manual drive mode. The landmark information can be acquired together with the map information from the outside via the communication unit 7. The landmark information preliminarily stored in the memory unit 12 includes information on a landmark that can be recognized in a limited time zone (e.g., daytime) as illustrated in FIG. 2A. The landmark information also includes information on whether or not the landmark has illumination as the type of the landmark.

The landmark recognition unit 131 recognizes a landmark around the subject vehicle based on the camera image captured by the camera 1a during traveling in the self-drive mode. For example, the landmark recognition unit 131 determines whether or not the camera image includes the landmark by performing processing of pattern matching between various landmark images preliminarily stored in the memory unit 12, and thereby recognizes the landmark. The landmark recognition unit 131 also recognizes the position and type (outline) of the landmark based on the preliminarily stored landmark information.

The landmark determination unit 132 determines whether or not the mode of the landmark recognized by the landmark recognition unit 131 changes depending on a time zone, that is, whether or not the landmark has a different mode in different time zones. The time zone refers to a certain period of time from a certain time to a certain time in a day, for example, a period of time of one hour or more. The different time zones are, for example, daytime and nighttime. Different time zones with intermediate times different from each other by at least approximately several hours, such as morning and afternoon, correspond to different time zones. Different modes of a landmark refers to the case where actual landmark modes (e.g., outline) are the same but may be recognized as being different from each other on a camera image. A landmark whose mode on the camera image changes depending on a time zone is hereinafter referred to as a variable landmark.

For example, when the daytime image 200A in FIG. 2A is compared with the nighttime image 200B in FIG. 2B, the landmarks of the division line and the sidewall (images 201 and 202) are recognized as being in the same mode on the camera image. In contrast, the landmarks of the building and the streetlight (images 203 and 204) are not recognized as being in the same mode between daytime and nighttime. The landmark determination unit 132 determines such landmarks of the building and the streetlight as variable landmarks. That is, the landmarks of the streetlight and the building with illumination have a mode that changes on the camera image when the illumination is turned on at night. The landmark determination unit 132 thus determines whether or not the mode of a landmark changes depending on a time zone such as daytime and nighttime based on landmark information such as the presence or absence of illumination preliminarily stored in the memory unit 12.

When the landmark determination unit 132 determines that the landmark recognized by the landmark recognition unit 131 is a variable landmark, the memory control unit 133 deletes information on the variable landmark from the map information stored in the memory unit 12. As a result, information on an uncertain landmark that may fail to be recognized depending on a time zone is deleted, and the storage capacity of the memory unit 12 can be reduced. The memory unit 12 thus stores information on a stable landmark (referred to as invariable landmark) whose mode does not change depending on the time zone.

The position estimation unit 134 estimates the subject vehicle position based on a landmark recognized by the landmark recognition unit 131 during traveling in the self-drive mode. That is, the position estimation unit 134 identifies a landmark in a camera image by comparing landmark image information preliminarily stored in the memory unit 12 with information on the image captured by the camera 1a during traveling. The position estimation unit 134 recognizes the subject vehicle position based on the position of the landmark in response to a signal from the sensor 1b. The landmark stored in the memory unit 12 is an invariable landmark whose mode does not change depending on a time zone. The position estimation unit 134 can thus accurately estimate the subject vehicle position both day and night.

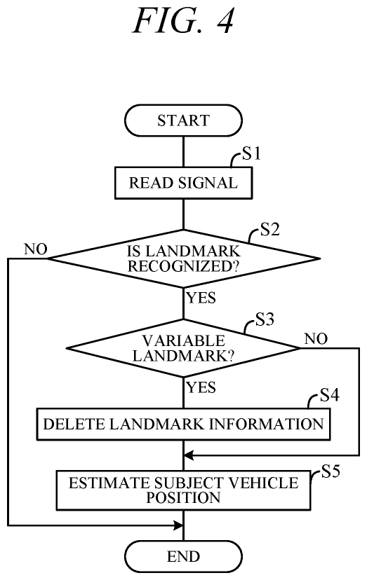

FIG. 4 is a flowchart illustrating an example of processing executed by the controller 10 in FIG. 3 in accordance with a predetermined program. The processing in the flowchart is started during, for example, traveling in the self-drive mode, and repeated at a predetermined cycle. In an initial state, the memory unit 12 stores information on both of a variable landmark and an invariable landmark. In the following processing, the subject vehicle position is estimated at the same time as the variable landmark is deleted.

As illustrated in FIG. 4, first, in S1 (S: processing step), signal are read from the camera 1a and the sensor 1b. In S2, it is determined whether or not a landmark is recognized around the subject vehicle based on the camera image. When a positive determination is made in S2, the processing proceeds to S3, and when a negative determination is made, the process ends. In S3, it is determined whether or not the recognized landmark is a variable landmark. More specifically, it is determined whether or not information, which is preliminarily stored in the memory unit 12, on a landmark that corresponds to the recognized landmark includes information indicating that the landmark includes illumination. It may be determined whether or not the landmark is a variable landmark by determining whether or not the landmark has illumination based on the camera image.

When a positive determination is made in S3, the processing proceeds to S4. When a negative determination is made, S4 is skipped and the processing proceeds to S5. In S4, information on the variable landmark in the memory unit 12 is deleted. In S5, matching between the landmark recognized in S2 and a landmark stored in the memory unit 12 is performed to identify the landmark around the subject vehicle. That is, a landmark corresponding to the landmark recognized by the camera image is identified from landmarks, whose position information has been known, stored in the memory unit 12. Specifically, when images have a matching rate of a predetermined value (e.g., 90%) or more, a landmark that corresponds to the landmark recognized by the camera image and that is stored in the memory unit 12 is identified. A position (relative position) of the subject vehicle relative to the identified landmark is determined based on signal from the sensor 1b to estimate the subject vehicle position.

The operation of the vehicle position estimation apparatus 50 according to the present embodiment is summarized as follows. In the memory unit 12, information on the variable landmark and the invariable landmark is stored without preliminarily distinguishing both the landmarks. When the subject vehicle travels in the self-drive mode, for example, during the day, a landmark around the subject vehicle is recognized by the camera image, and the subject vehicle position is estimated based on the landmark (S2→S3→S5). At this time, as illustrated in FIG. 2A, when the landmarks of the streetlight and the building (images 203 and 204) are recognized by the camera image (daytime image 200A), information on the variable landmark is deleted from the memory unit 12 since the landmark is a variable landmark that changes depending on a time zone (S3→S4). As a result, the subject vehicle position is estimated based on information on the invariable landmark whose mode does not change both day and night (S5). As a result, the subject vehicle position can be accurately estimated.

According to the present embodiment, the following function effects can be achieved.

(1) The vehicle position estimation apparatus 50 according to the present embodiment includes: a memory unit 12 that stores map information including information on a landmark; a camera 1a that detects an external situation of a subject vehicle; a landmark recognition unit 131 that recognizes a landmark around the subject vehicle based on the information on the external situation detected by the camera 1a; a landmark determination unit 132 that determines whether or not a mode of the landmark recognized by the landmark recognition unit 131 changes depending on a time zone; the memory control unit 133 that controls the memory unit 12 to delete information on the landmark that is determined to change depending on the time zone by the landmark determination unit 132, that is, information on a variable landmark from the map information stored in the memory unit 12; and the position estimation unit 134 that estimates a subject vehicle position based on the map information stored in the memory unit 12 (FIG. 3).

As described above, information on a variable landmark whose mode on a camera image may change depending on the time zone is deleted, so that information on a stable invariable landmark remains in the memory unit 12. The subject vehicle position is estimated based on the information on the invariable landmark. As a result, erroneous estimation of the subject vehicle position can be prevented, and the accuracy of estimating the subject vehicle position is improved. Since information on a variable landmark is deleted, the storage capacity of the memory unit 12 can be reduced.

(2) When the landmark recognized by the landmark recognition unit 131 has illumination, the landmark determination unit 132 determines that the mode of the landmark changes depending on the time zone (FIG. 2A). When the landmark has illumination, the mode on the camera image is often changed by turning on and off the illumination (FIG. 2B). The subject vehicle position can be satisfactorily estimated by not using information on the landmark with illumination for estimating the subject vehicle position.

(3) The landmark recognition unit 131 recognizes the landmark around the subject vehicle based on information on the external situation detected by the camera 1a in the first time zone (e.g., daytime). The landmark determination unit 132 determines whether or not the mode of the landmark recognized by the landmark recognition unit 131 changes in the second time zone (e.g., nighttime) different from the first time zone. For example, the landmark determination unit 132 determines whether or not an image changes by determining whether or not a camera image obtained in the first time zone is a predetermined image (e.g., image including a streetlight) that changes in the second time zone, or comparing the mode of a camera image obtained during actual traveling in the second time zone with that of the camera image in the first time zone. This allows satisfactory estimation of the subject vehicle position both during the day and at night.

The above-described embodiment can be varied into various forms. Some variations will be described below. Although, in the above-described embodiment, the external situation of the subject vehicle is detected by an external sensor group 1 such as the camera 1a, a detection device may have any configuration as long as the detection device detects the external situation for generating a map. The external situation may be detected by a LiDAR and the like instead of or together with the camera 1a. Although, in the above-described embodiment, the landmark recognition unit 131 recognizes a landmark around the subject vehicle based on information on the external situation detected by the camera 1a in the first time zone (daytime) and the second time zone (nighttime), the first time zone and the second time zone are not limited to the above-described time zones. The first time zone may be nighttime, and the second time zone may be daytime. The first time zone may be time zone in the morning, and the second time zone may be time zone in the afternoon. That is, as long as the time zones are different from each other, any of the first time zone and the second time zone may be adopted.

Although, in the above-described embodiment, the landmark determination unit 132 determines whether or not the mode of a landmark changes depending on a time zone, that is, whether the landmark is a variable landmark, based on whether or not the recognized landmark has illumination, the landmark determination unit 132 may make the determination by using other criteria. For example, the landmark determination unit 132 may determine whether or not a landmark is movable, and then determine a movable landmark as a variable landmark having a mode that changes depending on a time zone. That is, the landmark determination unit 132 may determine whether or not a landmark is provided with an object that causes erroneous recognition of the landmark on a camera image.

Although, in the above-described embodiment, the memory control unit 133 deletes information on the variable landmark preliminarily stored in the memory unit 12 while the subject vehicle travels in the self-drive mode, the memory control unit 133 may delete the information on the variable landmark during traveling in the manual drive mode, and recognize the subject vehicle position in the self-drive mode based on information on a landmark (invariable landmark) after deletion. The deleted landmark information may be transmitted to another vehicle via a communication unit to be used when the other vehicle estimates the position of the other vehicle.

Although, in the above-described embodiment, the memory control unit 133 controls the memory unit 12 to delete information on a landmark (variable landmark) determined to change depending on the time zone by the landmark determination unit 132 from map information stored in the memory unit 12, the memory control unit 133 may cause the memory unit 12 to store information on a landmark (invariable landmark) determined not to change depending on the time zone by the landmark determination unit 132. That is, a memory control unit may have any configuration as long as the memory control unit controls the memory unit 12 to store information on a landmark recognized by the landmark recognition unit 131 in accordance with a determination result of the landmark determination unit 132.

In the above embodiment, the example in which the self-driving vehicle includes the vehicle position estimation apparatus has been described. However, the present invention can be similarly applied to a case where a manual driving vehicle having or not having a driving support function estimates a position of the subject vehicle.

The present invention can also be used as a vehicle position estimation method including recognizing a landmark around a subject vehicle, based on an external situation around the subject vehicle detected by a detection device such as a camera 1a, determining whether the landmark recognized is a variable landmark, a mode of the variable landmark changing in accordance with a time zone, storing a map information including an information on the landmark recognized, in accordance with a determination result, and estimating a position of the subject vehicle, based on the map information stored.

The above embodiment can be combined as desired with one or more of the above modifications. The modifications can also be combined with one another.

According to the present invention, it is possible to estimate a position of a subject vehicle with high accuracy based on an information on a landmark.

Above, while the present invention has been described with reference to the preferred embodiments thereof, it will be understood, by those skilled in the art, that various changes and modifications may be made thereto without departing from the scope of the appended claims.

What is claimed is:

1. A vehicle position estimation apparatus comprising:
a detection device that detects an external situation around a subject vehicle; and
an electronic control unit including a microprocessor and a memory connected to the microprocessor, wherein
the memory is configured to store a map information including an information on a landmark, and
the microprocessor is configured to perform:
recognizing the landmark around the subject vehicle, based on an information on the external situation detected by the detection device;
determining whether the landmark recognized is a variable landmark, a mode of the variable landmark changing in accordance with a time zone;
controlling the memory so as to store the information on the landmark recognized, in accordance with a determination result; and
estimating a position of the subject vehicle, based on the map information stored in the memory.

2. The vehicle position estimation apparatus according to claim 1, wherein
the microprocessor is configured to perform
the controlling including controlling the memory so as to delete the information on the landmark determined to be the variable landmark from the map information stored in the memory.

3. The vehicle position estimation apparatus according to claim 1, wherein
the microprocessor is configured to perform
the determining including determining that the landmark is the variable landmark when the landmark recognized has an illumination.

4. The vehicle position estimation apparatus according to claim 1, wherein
the microprocessor is configured to perform
the recognizing including recognizing the landmark around the subject vehicle, based on the information on the external situation detected by the detection device in a first time zone, and
the determining including determining that the landmark is the variable landmark when the mode of the landmark recognized in the first time zone changes in a second time zone different from the first time zone,
the first time zone is one of a daytime and a nighttime, and
the second time zone is another of the daytime and the nighttime.

5. The vehicle position estimation apparatus according to claim 4, wherein
the microprocessor is configured to perform
the determining including determining whether the landmark recognized in the first time zone is the variable landmark, based on the information on the external situation detected by the detection device in the second time zone

6. The vehicle position estimation apparatus according to claim 4, wherein
the detection device is a camera, and
the microprocessor is configured to perform
the determining including determining that the landmark recognized is the variable landmark when a matching rate of an image of the landmark detected by the camera in the first time zone and the image of the landmark detected by the camera in the second time zone is less than a predetermined value.

7. The vehicle position estimation apparatus according to claim 1 wherein
the subject vehicle is configured so that a drive mode is changeable between a manual drive mode traveling with a driving operation by a driver and a self-drive mode traveling without the driving operation by the driver, and
the microprocessor is configured to perform
the determining including determining whether the landmark recognized during traveling in the manual drive mode is the variable landmark, and
the estimating including estimating the position of the subject vehicle during traveling in the self-drive mode based on the map information stored in the memory.

8. A vehicle position estimation apparatus comprising:
a detection device that detects an external situation around a subject vehicle; and
an electronic control unit including a microprocessor and a memory connected to the microprocessor, wherein
the memory is configured to store a map information including an information on a landmark, and
the microprocessor is configured to function as:
a landmark recognition unit that recognizes the landmark around the subject vehicle, based on an information on the external situation detected by the detection device;
a landmark determination unit that determines whether the landmark recognized by the landmark recognition unit is a variable landmark, a mode of the variable landmark changing in accordance with a time zone;
a memory control unit that controls the memory so as to store the information on the landmark recognized by the landmark recognition unit in accordance with a determination result by the landmark determination unit; and
a position estimation unit that estimates a position of the subject vehicle, based on the map information stored in the memory.

9. The vehicle position estimation apparatus according to claim 8, wherein
the memory control unit controls the memory so as to delete the information on the landmark determined to be the variable landmark by the landmark determination unit from the map information stored in the memory.

10. The vehicle position estimation apparatus according to claim 8, wherein
the landmark determination unit determines that the landmark is the variable landmark when the landmark recognized by the landmark recognition unit has an illumination.

11. The vehicle position estimation apparatus according to claim 8, wherein
the landmark recognition unit recognizes the landmark around the subject vehicle, based on the information on the external situation detected by the detection device in a first time zone,
the landmark determination unit determines that the landmark is the variable landmark when the mode of the landmark recognized in the first time zone changes in a second time zone different from the first time zone,
the first time zone is one of a daytime and a nighttime, and
the second time zone is another of the daytime and the nighttime.

12. The vehicle position estimation apparatus according to claim 11, wherein
the landmark determination unit determines whether the landmark recognized by the landmark recognition unit in the first time zone is the variable landmark, based on the information on the external situation detected by the detection device in the second time zone

13. The vehicle position estimation apparatus according to claim 11, wherein
the detection device is a camera, and
the landmark determination unit determines that the landmark recognized by the landmark recognition unit is the variable landmark when a matching rate of an image of the landmark detected by the camera in the first time zone and the image of the landmark detected by the camera in the second time zone is less than a predetermined value.

14. The vehicle position estimation apparatus according to claim 8, wherein
the subject vehicle is configured so that a drive mode is changeable between a manual drive mode traveling with a driving operation by a driver and a self-drive mode traveling without the driving operation by the driver,
the landmark determination unit determines whether the landmark recognized by the landmark recognition unit during traveling in the manual drive mode is the variable landmark, and
the position estimation unit estimates the position of the subject vehicle during traveling in the self-drive mode based on the map information stored in the memory.

15. A vehicle position estimation method comprising:
recognizing a landmark around a subject vehicle, based on an external situation around the subject vehicle detected by a detection device;
determining whether the landmark recognized is a variable landmark, a mode of the variable landmark changing in accordance with a time zone;
storing a map information including an information on the landmark recognized, in accordance with a determination result; and
estimating a position of the subject vehicle, based on the map information stored.
